(19) United States
(12) Patent Application Publication
(10) Pub. No.: US 2008/0299052 A1
(43) Pub. Date: Dec. 4, 2008

(54) Formulation to Prevent Plaque Formation

(76) Inventor: Olof Torgny Sjodin, Surrey (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/911,529

(22) PCT Filed: May 9, 2006
(86) PCT No.: PCT/GB06/01699

§ 371 Date: May 20, 2008

(30) Foreign Application Priority Data
May 9, 2005 (GB) 0509437.0

(51) Int. Cl. A61Q 11/00

(52) U.S. Cl. 424/53

(57) ABSTRACT

A composition for preventing plaque formation comprises; 98.267 kg deionised water; 0.2 kg delmopinol; 0.01 kg sodium saccharide; 0.02 kg herb flavour COD 76634-34; 1.5 kg 99.5% ethanol; and 0.003 kg sodium hydroxide.

### FIELD OF THE INVENTION

The present invention relates to the prevention of plaque formation.

### BACKGROUND TO THE INVENTION

The occurrence of dental caries and parodontitis appears to be the result of complex biological interactions of various microorganisms forming a part of the dental plaque, i.e. the deposit normally formed on the surfaces of the teeth. Chronic parodontitis, apparently the most common cause of tooth loss, is an inflammatory process of the supporting tissues of the teeth and about as prevalent as caries.

Formation of dental caries and parodontitis have a common cause, viz. the formation of dental plaque. The plaque is a deposit upon the tooth surface and contains primarily bacteria and saliva components. The structure of dental plaque changes from the soft initial stage to the formation of a harder and water-insoluble plaque which can cause caries as well as parodontitis. In an effort to maintain oral and dental hygiene a large variety of different substances are presently used. Such substances can be used in toothpastes, tablets, mouthwashes and the like.

A wide variety of chemical and biological agents have been suggested for the removal of dental plaque after it is once formed or for the inhibition of the formation of dental plaque. However, mechanical removal of dental plaque has hitherto been the most effective method. For the inhibition of dental plaque in other ways, the use of different types of antibiotics, chemotherapeutical agents and disinfectants, fluorine compounds, organic phosphatases, chelate-forming agents, emulsifiers, etc. has been suggested. Examples of such agents are penicillin (antibiotic), chlorohexidine and 8-hydroxyquinoline (disinfectants), ethylenediamine tetraacetate (chelate-forming agent), NaF (strengthening of the tooth enamel).

Some of these previously suggested agents have exhibited insignificant effects. Others such as antiseptic and antibiotic agents can certainly be effective but often cause side effects which must be considered worse than the condition removed.

It is now clear that the causes of the plaque-formation are of a very complicated nature, and for the chemical removal thereof it has been found necessary to employ compounds of a very specific chemical structure. To be useful for this purpose the compounds must have properties such as a low antibacterial effect, very low toxicity and lack undesired side effects such as discolouration of the tooth enamel.

Delmopinol is a morpholino compound that has utility in the treatment of the oral cavity, especially tooth surface, and for the removal or inhibition of dental plaque. The compound and its manufacture are disclosed in U.S. Pat. No. 4,894,221.

### SUMMARY OF THE INVENTION

The present invention is based on the realisation that a specific formulation comprising delmopinol is advantageous in the prevention of plaque formation.

According to the present invention, a formulation suitable for the prevention of plaque formation, comprises, per 100 kg, 98.267 kg deionised water; 0.2 kg delmopinol HCl; 0.01 kg sodium saccharide; 0.02 kg herb flavour COD 76634-34; 1.5 kg 99.5% ethanol; and 0.003 kg sodium hydroxide.

### DESCRIPTION OF THE INVENTION

The compounds for use in the present invention are known and available.

Delmopinol is the International Non-proprietary Name (INN) of 3-(4-propylheptyl)-4-morpholine thanol with CAS No. 79874-76-3. Delmopinol hydrochloride salt has the CAS No. 98092-92-3. The compound may be prepared in any convenient way and is available from commercial sources. EP0426826-A describes the process for the production of delmopinol. the content of this publication is incorporated herein by reference. Preferably, the hydrochloride salt of delmopinol is used in the formulation.

The formulation/medicament may be brought into contact with the oral cavity in a conventional way. For example, the formulation may be prepared in a solution as a mouthwash and the solution brought into contact with the surface.

The medicament may be delivered in any suitable form or amount that achieves the desired effect.

Preferably, the formulation is a mouthwash.

The formulation of the invention has shown desirable activity in preventing plaque formation.

1. A composition comprising, per 100 kg,
98.267 kg deionised water;
0.2 kg delmopinol;
0.01 kg sodium saccharide;
0.02 kg herb flavour COD 76634-34;
1.5 kg 99.5% ethanol; and
0.003 kg sodium hydroxide.

2. The composition according to claim 1, wherein the delmopinol is the delmopinol hydrochloride salt form.
